(19) United States
(12) Patent Application Publication
(10) Pub. No.: US 2010/0049591 A1
(43) Pub. Date: Feb. 25, 2010

(54) COMMUNICATION SYSTEM

(75) Inventors: Bo Mattsson, Taby (SE); Oscar Carlsson, Stockholm (SE); Marcus Almgren, Arsta (SE); Torbjörn Gyllebring, Sodertalje (SE); Kristoffer Roupé, Stockholm (SE)

Correspondence Address: VENABLE LLP, P.O. BOX 34385, WASHINGTON, DC, 20043-9998, US

(73) Assignee: CINT AB, Stockholm (SE)

(21) Appl. No.: 12/441,779

(22) PCT Filed: Sep. 18, 2007
(86) PCT No.: PCT/SE2007/050663

§ 371 Date: Oct. 5, 2009

Related U.S. Application Data
(60) Provisional application No. 60/825,932, filed on Sep. 18, 2006.

(30) Foreign Application Priority Data
Sep. 18, 2006 (SE) 0601918-6

(51) Int. Cl. G06Q 10/00; G06F 15/16; G06F 3/048

(52) U.S. Cl. 705/10; 709/204; 709/206; 715/760

(57) ABSTRACT

Saving time and middle-men costs in performing one-country or multi-country market research studies. Users are permitted to collaborate directly on assets deemed by the user to be non-competitive, and by automizing many functions that are today handled manually. Also, CPX is utilized, which lets buyers and sellers of access trade this access in a wholly open environment, which decreases trading friction and increases the flow of pricing information.

### TECHNICAL FIELD

The present invention relates in general to the field of market research. The invention relates in particular to internet based field data collection. The present invention relates to a system for managing data. The present invention also relates to a method for managing data within a network system. The present invention also relates to a computer programme comprising a programme code for performing the method steps according to the invention when the computer programme is run on a computer.

### DEFINITIONS OF TERMS USED HEREIN

Panel: Register of people that have volunteered in a specified manner to take surveys, the number of panels is unlimited. According to one embodiment of the invention the number of panels is at least one. According to one embodiment of the invention the number of panels is a plurality.

Panellist: A person who is part of the panel, or a recipient of a message associated with a survey as depicted herein.

Seller: Owner of this register who markets the panel through CPX to buyers, the number of sellers is unlimited. According to one embodiment of the invention the number of sellers is at least one. According to one embodiment of the invention the number of sellers is a plurality.

Panel provider: seller.

Buyer: A user of the register, the number of users is unlimited. According to one embodiment of the invention the number of buyers is at least one. According to one embodiment of the invention the number of buyers is a plurality.

Herein after ASq also is also referred to as CPX APM (Automated Project Manager); Word Coder and ACq are also referred to as CPX Word Coder; and Survey Tool and cpx ST are also referred to as CPX Survey Tool.

### BACKGROUND OF THE INVENTION

As of today, the market share of internet based research is about 45-50% of a total market research business conducted in the US. In Europe the average figure is about 20%, growing at about 30% a year.

A typical client is a multinational retail orientated firm which uses one of the global market research firms to conduct the study. Very often these do not have in-house capability to reach all necessary markets, why they usually give part of the project to so-called “panel providers”. These, in their turn, have specialized in creating and maintaining large pools of people that have agreed to take surveys.

A normal project size is about 300-1500 interviews in each market, and the average value of such a project is around USD3-10 per interview, depending on a number of criteria (mainly number of interviews, length in minutes of interviews, and incidence rate).

Given each party's ability to deliver, a 10 market project, may involve 4-7 different vendors, to accomplish the project, from a field-data point of view. The field data project starts with the market research firm going into the market asking for prices from the global panel providers, and these, in their turn, request prices from markets they do not cover, or, if the project is non-standard, markets where they need a top-up. As prices are collected, a procedure that may take weeks, and involve hundreds of contacts, the vendors are selected, and eventually the project can go into field.

Going into field means sending out the links necessary to be presented to the chosen respondents in each sample, together with a test link in each market. This test link may or may not create a number of changes to the questionnaire, and before it is sent out there are numerous contacts taken again.

As the project starts, a project manager at the market research firm controls the project continuously, together with the one or two panel providers that were chosen, and these in their turn control the projects in the markets they themselves do not cover. This entails hundreds of contacts, until the field data project is called off, and all the needed completed interviews are in.

Today very many firms build so-called access panels to address what they believe is a necessary solution to be able to keep competition at bay. Since this process is happening at almost all firms (including end-clients) at the same time, output of panel-lists is climbing very fast.

So, in essence, both the actual questionnaire handling and the data collection is a very manual and very non-tech task.

The process, system and method according to what is depicted above, suffers from at least the following drawbacks:

1—Lengthy in time in all aspects (request handling, buying, communication, collecting data, etc), and involving a large number of people;

2—Very many people at different firms involved (“whispering mistakes” almost unavoidable);

3—Costly, since there are many different layers involved;

4—Low or no transparency in project delivery (the black-box mentality in this market is well-known with ridiculous figures regarding panel sizes being very common);

5—Build-up of panels risks becoming a global panel “bubble” which, when it bursts, will drive income on sampling down below the needed level just to keep up with write-downs, which will risk create massive write-offs;

6—No or low level of collaboration, not even between the vendor and the buyer, and definitely not between different vendors;

7—No or little automation in the actual project process—not in the invitations send outs, not in the sampling, not in the project controlling part, and not in the send outs. This simply involves a high number of people, doing low-skilled, manual work, which makes the whole process prone to mistakes;

8—The industry as such has a tradition of solving cost pressure issues by out-sourcing manual labour to low-cost countries, or by merging. In-sourcing solutions is not very common, which has led to an industry that as a whole is not very cost-effective;

9—The relative high degree of mistakes, create a demand for costly quality-control systems, which in their turn drive costs upwards;

10—The extremely fragmented market-place, deters and hinders formats and interfaces that can be commonly agreed upon (which would save costs);

11—Word coding, e g, is usually done manually, even though there are other computer systems addressing this task. These work, however, only vertically, i.e. the user can only use words earlier coded by the vendor or by himself;

12—Target group weighting is a common procedure in all market research, as a way to reduce costs (if there are not enough answers in one target group, that group is simply increased in weight in accordance to what it should have been if the number of answers had been large enough. Needless to say, this has a negative effect on the result as such.

Thus, there is a need to overcome the mentioned drawbacks of prior art arrangements.

### SUMMARY OF THE INVENTION

An object of the invention is to overcome the drawbacks mentioned above.

Another object of the invention is to provide a more cost effective system and method for questionnaire handling and data collection within such a system.

Yet another object of the invention is to provide an improved system and method for questionnaire handling and data collection

The problems are solved a project managing unit for managing at least one market research involving a survey to be answered by a plurality of panellists, said unit comprising:
means for receiving a predefined survey information comprising a predefined survey criterion;
means for repeatedly selecting a set of panellists chosen from at least one panel, said selection being based upon said received criterion and/or an updated information regarding survey answer status;
means for generating messages to be sent to the selected panellists, wherein each generated message comprises access information giving the addressed panellist access to the survey;
means for sending said generated messages to corresponding selected panellists;
means for determining and updating information regarding survey answer status so as to allow an iterative message sending process until a desired result is achieved.

The predefined survey criterion may comprise information about number of panel-lists and/or geographic residence of the panellist and/or gender and/or age of the panellists.

Each panel may comprise a dynamic predetermined set of panellists.

The determined information regarding survey answer status may comprise information about which panellists successfully have responded to the survey in a desired manner.

The result may be regarding whether a predetermined ratio of accepted responses to the survey has been achieved or not.

The means for sending said generated messages may be arrange to send the messages substantially periodic.

The determination may be based upon a successfully answered survey by a panel-list.

The messages may be e-mails.

The access information may be a link, said link being unique and associated with a selected panellist and, when activated, arranged to provide access to the survey.

A selected panellist may be prohibited from participating in more than one market survey at the same time, and where a selected panellist having answered the survey will be blocked from participating in other market researches for a predetermined period of time.

According to an aspect of the invention there is provided a method for managing at least one market research involving a survey to be answered by a plurality of panel-lists, wherein the method comprises the steps of:
receiving a predefined survey information comprising a predefined survey criterion:
repeatedly selecting a set of panellists chosen form at least one panel, said selection being based upon said received criterion and/or an updated information regarding survey answer status;
generating messages to be sent to the selected panellists, wherein each generated message comprises access information giving the addressed panellist access to the survey;
sending said generated messages to corresponding selected panellists;
determining and updating an information regarding survey answer status so as to allow an iterative message sending process until a desired result is achieved.

The method may comprise the steps of:
generating a predefined survey information comprising a predefined survey criterion; and
sending said predefined survey information.

The method may further comprise the steps of:
sending answers associated with the respective generated messages, and
generating an indication signal based upon said answer sending step, which signal may be taken into consideration in said determining step.

The method may further comprise the step of:
coding said answers so as to correct faulty information, said coding step involves the steps of performing a matching procedure between words of the answers and a set of predetermined words, and eventually correcting misspelled words of the answers based upon said matching procedure.

The method may further comprise the step of:
storing the answers so as to allow subsequent analysis.

The access information may be in the form of a link, said link being unique and associated with a selected panellist and, when activated, arranged to provide access to the survey.

The method may further comprise the steps of:
prohibiting a selected panellist from participating in more than one market survey at the same time, and
blocking a selected panellist having answered the survey, from participating in other market researches for a predetermined amount of time.

The method may comprise the step of;
invoicing a buyer sending a survey information comprising a predefined survey criterion, which is to managed as according to the method steps depicted above.

The method may comprise the step of:
invoicing a buyer using the coding step.

The invention also relates to a word coding unit for coding provided information, comprising:
means for storing at least one context, wherein said context is a set of words being associated with a correctly spelled word:
means for coding answers to a survey managed by a project unit 10, so as to correct faulty information, said coding means comprises means for performing a matching procedure between words of the answers and a relevant context and eventually correcting misspelled words of the answers based upon said matching procedure to determine the corrected spelled word.

The invention also relates to a word coding unit for coding provided information comprising:
means for storing at least one context, wherein said context comprises a set of words being associated with a correctly spelled word;
coding means for coding the provided information based upon said at least one context;
means for adding and/or deleting one or more words to/from the context; and
means for providing access to the at least one context for an external user of the word coding unit.

The invention also relates to a system for managing at least one market research, comprising at least one first communication terminal being operated by a buyer and being arranged for communication with the project managing unit via a network; said project managing unit also being arranged for communication with a plurality of second communication terminals being operated by panellists.

The system for managing at least one market research may further comprise a word coding unit.

The network may be the Internet.

A plurality of market researches may involve mutually different predefined pieces of survey information each comprising a predefined unique survey criterion.

A panellist may send an answer to the survey directly to a buyer operating the first communication terminal from the second communication terminal.

One aspect of the invention relates to a computer programme comprising a programme code for performing the method steps, when the computer programme is run on a computer.

One aspect of the invention relates to a computer programme product comprising a program code stored on computer-readable media for performing the method steps, when the computer programme is run on the computer.

One aspect of the invention relates to a computer programme product directly storable in an internal memory of a computer, comprising a computer programme for performing the method steps, when the computer programme is run on the computer.

According to an aspect of the invention the problems described above can be solved by creating a global marketplace where the actors collaborate on the resources that are not critical to their success, i.e. the access to panels and the actual process for collecting data, since both of these are almost identical at all firms. By “harnessing” the power of the internet to connect different actors, this can be accomplished in totally new ways by using new technology solutions, where collaboration is the main mean of driving costs down and at the same time drastically improve efficiency.

The idea presented here, involves CPX, which is a global marketplace for sharing on panels, where sellers can resell shelf-space and buyers can access those panels almost as if the panels had been their own. This is done through an internet based solution, which enables this sharing to happen in a perfectly secure and stable environment, where industry-standard norms are by definition followed (and for everyone to see), and privacy issues are handled as according to local laws.

CPX then, is on the one hand a Panel Management System (the sell side) and on the other hand a Sample Management System (the buy side), coupled with an Automated Sampling technology as well as an Automated Word-coder. CPX is open to use by anyone as long as the given industry standard is accepted by the seller and the buyer. This openness creates a place where any firm with a dedicated access panel can join and start selling to others, which in effect means that the choice for the buyer suddenly becomes broader and much more readily available.

This translates into a solution where a market research firm in, say, São Paolo can from his or her PC create a project on January 1^{st}, create the survey, set the timing and recurrent scheme if it is a tracking survey (continuously monitor for example consumer awareness of a certain brand) for 4 surveys a month, with 50 males and 50 females answering each week, connect to a sample from e g large cities in Poland, Portugal, Russia, and the US, from 40 different panel providers and push the start button, with the total amount of time spent being ⅕ of what it today takes to just sample one country.

According to a preferred embodiment of the invention the CPX is arranged to send out an invitation email, containing a CPX unique link that when the respondent clicks on it, connects through the CPX server to the link connected to exactly that person and to that survey. The survey pops up and the respondent starts answering it. When he/she is finished, the session cookie placed by CPX sends a signal to CPX that he/she is finished (or screened-out, or whatever other action there may be), CPX updates the project, where the Automated Sampling technology (ASq) springs into action, by calculating that in order to be done by the week's end, CPX has to send out x amount of invitations, taking into account the history of the panel involved, the panellist involved, and the time of the year. ASq calculates the residual need, draws a new sample according to the original specifications, and have new invitations sent out, after which the same procedure starts all over again, until the needed number of completed interviews has been reached.

As the respondents answer the survey, the data thus collected is stored by the survey tool. If the survey tool which is used, is CPX Survey Tool (i.e. the survey tool embedded in CPX) all open answers may be directed to the Automated Coding technology (ACq) and processed by this.

ACq is a word coder that codes words, and collates them into neat piles. The actual coding is done by the system, and works specifically on misspellings. The ACq is based on an artificial intelligence solution where the database it works against is created by its users, collaboratively. This means that one user may use another user's coded contexts. A context can be car brands in a specific market, or any words used in Spanish. The algorithm doing the actual coding, codes for about 10,000 words per second (depending on hardware setup), and will leave a result file where all words are accounted for and stacked into neat piles of their most probable meaning. In case ACq cannot determine a probability level over a certain threshold set by the user, it will present the user with a residual of words that the user will have to code. This manual coding is automatically stored in the database and can be used by any other user. In such a manner all coded words will be in the public domain and to the benefit of all users (in the context addressed), and over time this residual will approach zero in all contexts and markets. By connecting overlapping contexts, contexts can be imported into other areas (e g the car brands in the US that are also used in Great Britain, may be imported to that context).

### ADVANTAGES OF THE INVENTION

1—Massive time reductions—as shown in Table 2, even for a relatively small international project, the savings are 70-80%, if all services here described are used together. For larger projects the savings are even greater.

2—High quality gains, since very boring manual tasks are automatized. The number of mistakes per project will drop drastically.

3—Weighting is unnecessary. The system will just continue to work, until each target group has been filled. On the margin the cost for sending additional invitations is almost zero (whereas in a manual solution, the cost for doing this is prohibitively high, why weighting is commonplace).

4—The massive cost reduction in data collection, creates space for the user of this invention, to put more resources into higher-value services, such as analytics and counselling, something that the ineffective methods of today prohibit (the client is usually bound by budget restrains, why there are little room for what should rally matter—i.e. interpreting and understanding the data).

5—This creates a neutral platform for data collection. The system is totally open for anyone to use, as long as the uses agrees to “normal” behaviour.

6—The project manager remains in charge of the whole data collection process, regardless of if internal or external data sources are used, since he/she no longer is reliant on other people to perform (i.e. do not have to wait for a person in another country to answer an email, draw a new sample, or do a sendout).

7—CPX is an open marketplace, where the traded asset is the access to private individuals in order to perform market research. This marketplace set-up of course gives the uses easier access to better pricing information, and the information also is disseminated better and faster.

8—The transparent nature of CPX takes away a bunch of unnecessary checks and controls—there is no need to have a third-party audit of processes when you can watch the actual process yourself.

9—On-demand delivery. A multi-market study with an exceptionally short time frame can be bought, and executed in minutes, and deliver result within a day. ASq kicks in instantly, and sees to that the sample is filled in shortest possible way, regardless of the number of criteria and market used.

10—The collaboration techniques used, creates an environment where people can share on non-important knowledge, in order to save time and thus focus on more important factors.

Additional objects, advantages and novel features of the present invention will become apparent to those skilled in the art from the following details, as well as by practice of the invention. While the invention is described below, it should be understood that the invention is not limited to the specific details disclosed. A person skilled in the art having access to the teachings herein will recognise additional applications, modifications and embodiments in other fields, which are within the scope of the invention.

### BRIEF DESCRIPTION OF THE DRAWING

For a more complete understanding of the present invention and further objects and advantages thereof, reference is now made to the examples shown in the accompanying drawings, in which:

FIG. 1 schematically illustrates an overview of the system and method according to an aspect of the invention;

FIG. 2 schematically illustrates an overview of the system according to an aspect of the invention;

FIGS. 3a and 3b schematically illustrates a questionnaire including information pieces according to an aspect of the invention.

FIG. 4 schematically illustrates a graph depicting traditional work-flow.

FIG. 5 schematically illustrates a graph depicting CPX APM work-flow.

### DETAILED DESCRIPTION OF THE DRAWING

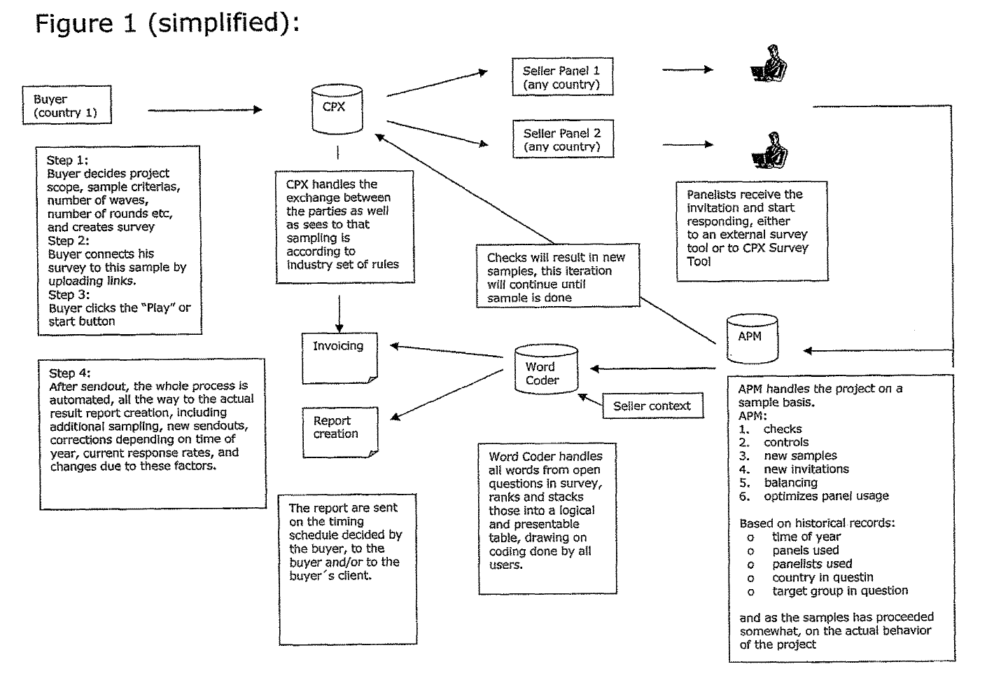

FIG. 1 schematically illustrates a project where the buyer in any country has a need to sample consumers in a number of different countries. At the same time this is going to be repeated four times, each time being a round, during the course of the following year. Each time the round involves sampling 4 different target groups divided into individualized sample sizes for each and every one of these target groups. Each group shall reach the desired sample size on a weekly basis, during the e g 8 weeks that the round consists of, as well as reaching the total number during that round, within the given 8 week time frame (which of course should be the same as the sum of the weeks/waves).

The buyer creates the survey in CPX ST (survey tool) or have already created it in any other tool. In order to get the full advantage of the other tools, and for the sake of the presentation, we here use the CPX ST. After being done with the survey creation as such, he/she uses the ASq (Automated Sampling technology) where he/she sets the criteria for the sample. These might be age, region, car ownership, size of sample per week (wave) per target group or per a number of waves (round). He/she may also attach any number of quotas on these waves and target group.

After having set the criteria, and “told” ASq which survey should be used in the sample, he/she simply pushes the start button, whereupon ASq starts doing the actual sampling according also to industry rules (which is presided over by CPX), and according to the set criteria. ASq will, as long as the project continues, oversee the whole process, ensuring that the project manager get the wanted sample in the markets where the project is run, and perform the needed number (per wave and round) of interviews. This control process is being handled according to historical data in the panels, time of year when the sample is being used (different times of year yields different respondent behaviour in different countries). ASq runs round the clock; and will continuously draw small samples and do small send outs, in order to minimize panel usage, and sourcing costs (over sampling always involves costs). As ASq and CPX ST continues interviewing consumers, the answers are continuously transferred to ACq (Automated Coding technology) which will code all the open answers of the survey (i.e. where the respondents have answered in their own words), and stack these together in presentable tables, in order to understand how many has answered this or that in different target groups. ACq works according to an algorithm an algorithm that recognizes words and their spelling in a given context, set and chosen by the user, regardless of language and textual appearance. On the dates set by the project manager, ASq and ACq will send the data to any reporting management tool, alternatively directly in raw data form to the project manager and/or the client of the project manager.

What this in short means, is that the project manager can start a project in January one year, and not having to touch it again during the year, regardless of:

a) Number of interviews per wave and round and target group;

b) Number of countries involved;

c) Number of criteria for the sample (which may be different for different target groups);

d) Number of quotas set on the project, country, wave, round or target group;

e) Number of open questions.

Functionality within the CPX product family:

CPX APM (Automated Project Manager)

Functionality.

CPX APM works together with an open panel source API (today that is CPX, but any similar service).

CPX APM is a highly developed tool that enables its user to perform field data tasks within the field of market research, with 15-20 times as high efficiency.

Field data collection is a very tedious task, and often of a repetitive nature. An example of this is given below, where a standard tracking project is given:

Project Specifications:

Markets: 11 (e g Britain, the US, France, Italy, Russia, etc)

Target groups: Males 14-22, females 14-22, males 23-35 with a car, females 23-35 with a car, females 23-45 with at least one child.

Size of sample: 55 interviews in each target group per week, except for the last one, where the sample size is 37.

Length of tracker: 52 weeks.

Calibration: ±5% on the week, zero on the month (i e., deviation on sample size is allowed by 5% in one specific week, but it should be zero on the month).

Traditional Work Flow:

When the questionnaires have been created and checked, 11 of them in this case, after translations, the project manager starts running the project by selecting the above mentioned samples. In case he/she does not have access to access panels in some of these countries, she sends unique links to the partner firm to work those specific countries, where another project manager do the same work. In this case, we take for granted that she has access. When the samples in one country have been drawn, she connects the links to this sample, checks if everything is correct, where-after she sends the first batch out.

After this, she turns her attention to the next country, and during the course of the day, she may be finished with the first batch of invitations in all 11 countries. She has probably made the sendouts large enough to ensure her that she will get most of the needed result during the course of the week. There is, however, a large quality loss doing it in this fashion, since people tend to have access to the internet, in a very different way. A person working in an office will see the invitation directly, while a carpenter will see it much later, and a person on a few days leave, will not see it until the weekend.

It also means that a large sendout on a Monday will return most completed questionnaires on Monday and Tuesday, leaving the other weekdays empty, which by itself creates a bias.

The way that she would like to work, in order to ensure a smooth progress curve, is of course to do much smaller samples, much more often, and have them sent out throughout the week. This would make the project management too costly, however, why she tries to optimize her work in a way that permits her to do more projects.

In this case she checks the projects two times more during the week, and each time she draws new samples wherever needed, in order to fulfil that weeks goal. That could mean another 40 samples connected to its specific links the first time, and perhaps 15 samples to finish off the project at the end of the week.

When the first week is finished, she starts all over again by drawing 55 new samples, connect each and every one of these with the correct links, and do the sendouts (for another 51 weeks . . . ).

CPX APM Work Flow

The project manager sets the criteria's needed for the project (i.e, target group criteria's in the needed countries). This she does only once, whereafter she presses the “Play” button and CPX APM kicks in.

CPX APM starts by comparing the result in those target groups in those countries in the projects preceding this one, in order to learn what the probable speed should be in order to reach the goal in one week, but by keeping the number of completed interviews the same on a daily basis. After having done that, CPX APM draws small samples in each target group in each market, connects automatically to the links to the questionnaire, and do the sendout.

After 4-6 hours, CPX APM checks how many interviews have been completed, changes, if need be, the former assessment on speed and size, draws new samples, fetches new questionnaires links, and do new sendouts.

This continues until the needed number of completed interviews is reached in all target groups during the week.

The time span on when CPX APM should do sendouts can be set arbitrarily, so as not to have sendouts sent out in the middle of the night.

Integration

As shown in FIG. 3, CPX (Cint Panel eXchange) the CPX APM, CPX Survey Tool, and CPX Word Coder, all together present the user with fully automated solution, which not only does away with the need for manual handling of a project, but also improves overall quality, due to the removal of costly processes which leads the project manager to handle projects in a less quality oriented way, and due to absence of manual handling (lack of human errors).

A project manager thus becomes an operator, rather than a manager, which sees as his or her main work task to oversee a process. When the criteria's have been chosen, and the questionnaire programmed, the CPX APM works seamlessly with the access panels provided by CPX, optimizes the usage of these, while at the same time sees to that the needed number of completed interviews get done within the give time frame, and does this on a smooth development curve.

The output, field data, is transferred in realtime in any given format, to any other database, of the user's choosing.

By using these solutions it is possible for an operator to handle up to 150 projects per month, including time for updating contexts, changing criteria's, change data formats when exporting, etc. The average number of projects that a typical project manager handles is around twenty projects, which means that he or she can become seven times as effective.

CPX Word Coder

The Word Coder codes answers given in plain text, a questionnaire form very often used in market research in order not to steer the respondent. It is a form very commonly used when assessing a particular brand, or any attitudinal study. The problem within the framework of doing field data collection on the internet, is how to code the given answers.

### Example

Within the above described example for cpx APM, there might be question asking:

“Please write the names or brands of cars that you can remember”.

The respondent puts down all the car brands that he/she can remember, it could e g., be Toyota, Buick, Mercedes, Chevrolet, BMW, etc.

The problem here is that perhaps as much as 25-50% of all words inserted will be misspelled, by typing errors, or by lack of knowledge.

This has to be rectified, and all brands must also be given a certain index number, in order to simplify classification at a later stage (what brand is “Top of Mind”).

The Word Coder does this, within a given context. These contexts are created by the user, or the user chooses to use already existing contexts, created by other users of the system.

A context is all brands or words commonly used within that “area of usage”, and includes also all misspellings connected to each and every brand within that context. The contexts may thus be e g., “Car brands in Germany”, or “Shampoo brands in France”, including all possible sorts of misspellings. Each context is owned by the user, and if someone else decides to use an existing context, the context is leased to that user, for this particular purpose.

This “marketplace of contexts” is created so as to make it possible for everyone to share on each other's contexts. The alternative would otherwise be that all users created more or less exact replicas of all the needed contexts, and used only by the user having access to those specific contexts.

By doing it in this fashion, coding is a shared utility, where the user can use contexts created by professionals in all other areas, globally, no matter what the context is, there is a high probability that the context already exists, and the coding will be done automatically, as the survey is being completed by the respondent.

An owner of a context gets paid for any usage, why there is a strong incentive for context-creators to make public their work. Any user may also improve the context as such, although ownership is not transferred. For a context to be admitted to the marketplace, it needs to have been in actual practice for some time, in order for all typical misspellings to surface, and also include almost 100% of all brands within that area of interest.

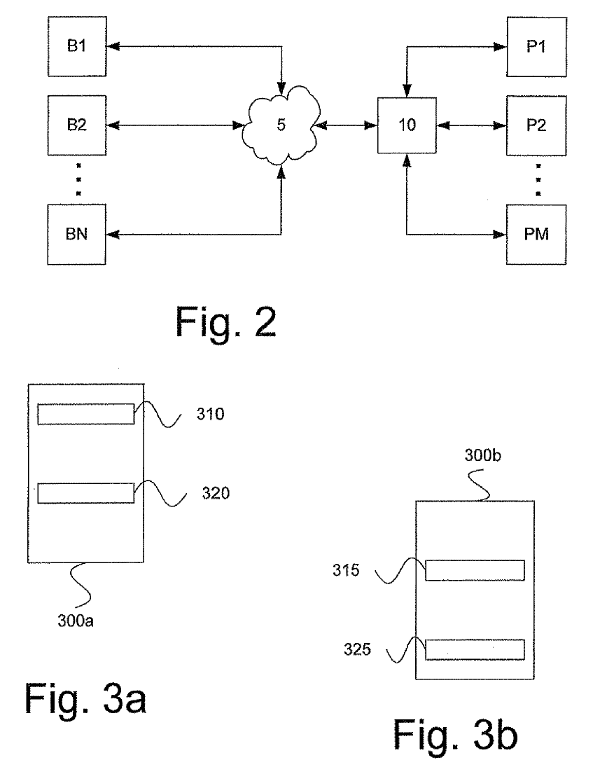

FIG. 2 schematically illustrates an overview of a system according to an aspect of the invention. An arbitrary number of buyer communication terminals B1-BN are arranged for communication with a project unit 10 via a network 5. N is an arbitrary positive integer, for example 5 or 1000. The project unit 10 is also referred to as CPX. The project unit 10 is arranged for communication with an arbitrary number of panellist communication terminals P1-PM. M is an arbitrary positive integer, for example 3 or 500. According to one embodiment of present invention one buyer is operating one buyer communication terminal. According to another embodiment of present invention two or more buyers are using one particular buyer communication terminal.

A buyer N may create a survey according to what is depicted above by means of a buyer communication terminal N. The buyer may initiate transmission of survey information comprising a predefined survey criterion to the project unit 10. The project unit 10 is arranged to store the received survey information. The project unit 10 is arranged to process the received survey information. The project unit 10 is arranged to manage a market research including the received survey information. Below, said processing of the received survey is depicted.

The project unit 10 is arranged to generate a selection of panellists, which are to be included in the particular market research, based upon the criteria set by the buyer. The criteria may be included in the transmitted survey information. According to one embodiment each panellist of a panel is operating one communication terminal.

The project unit 10 is also arranged to load links associated with the generated survey comprising particular questions or statements of the survey to be answered or commented by selected panellists.

The project unit 10 is arranged to generate a survey message and to send the survey message to a selected panellist. According to one embodiment the project unit 10 is arranged to generate and send substantially identical survey messages to each panel-list of the panel of relevance for the market survey. According to another embodiment the project unit is arranged to generate and send survey messages which are mutually different to each panellist of the panel of relevance for the market survey.

The survey message may include the loaded links. The survey message may be in the form of an e-mail. The message is further depicted with reference to FIG. 3a-3c.

FIGS. 3a, 3, 3c schematically illustrates information pieces 300a, 300b and 300c, respectively. FIG. 3a schematically illustrates a first information piece 300a comprising two information pieces information pieces 310 and 320. The first piece of information 300a is generated by the project unit 10 based upon the survey information provided by the buyer. The first information piece 300a is preferably included in a survey message. The information pieces 310 and 320 are according to an example a link and a statement relating to the survey. According to another example, one of the information pieces 310 and 320 is an advertisement.

The information pieces 310 and 320 are according to an example two different links corresponding to two different questions of the survey.

FIG. 3b schematically illustrates a second piece of information comprising two pieces of information 315 and 325. The piece of information 315 is corresponding to the piece of information 310 and is typically an answer to a question provided by means of the link as given in the piece of information 310. The piece of information 325 is corresponding to the piece of information 320 and is typically an answer to a question as defined in the piece of information 320 or as a response to a statement as defined in the piece of information 320.

Of course, the first piece of information 300a may comprise an arbitrary number of pieces of information and the second piece of information 300b may comprise a corresponding number of pieces of information.

### Example

Research firm X needs to perform for a client a multi-country study for beer. The study's aim is to continuously track the knowledge of the brand among a sample of typical consumer's, some of which are knowledgeable first-hand of the beer brand, and some of which are not. The target groups are women 20-35 years of age, living in large cities and men 20-50 years of age. Within each group a nationally representative sample is wanted.

In short, this is the desired project:

5 countries;

48 weeks/waves divided into 12 rounds (i.e. 4 waves in each round).

Reuse of respondent: after 40 weeks.

Target group 1: women 20-35 years of age, large cities (30% of total in each round).

Target group 2: men 20-50 years of age, large cities (70% of total in each round).

Number of interviews per wave:

Sample size: target group 1: 30, with a margin of 10% (i.e. the number may differ between 27-33 in each wave).

Target group 2: 70, with a margin of 5% (67-73 interviews per wave).

Sample size per round, target group 1: 120 with a zero margin.

Target group 2: 280 with a zero margin.

Two questions in the questionnaire are open-ended questions (i.e. the respondent is asked to put in their own input, which in this case is beer brand names).

Step 1

The project manager creates the survey in CPX ST (survey tool), goes to CPX ASq, where all the above mentioned criteria are put in, together with communication set-up (i.e. where to send the project result figures as the project moves along, and where to send the results).

The project manager could make a feasibility study first to check whether the study is possible, but in the case he/she has not, CPX ASq will now answer if it given the stock of booked samples during the course of the project can deliver the samples. In doing this, CPX ASq also checks for the following when checking the sample:
The respondent has not participated in a survey or a focus group in the same industry for the last x months (the value set by the user) as known by CPX;
The respondent is not locked up or booked by some other user;
A number of status values (no of total interviews, speed when completing surveys compared to the median speed of all respondents taken into account this respondents most probable hook-up to the internet), browser type, PC, mobile phone, OS's, etc.

If the project manager receives a “Yes” to the project, he/she is ready to go. The last thing is to connect CPX ASq with CPX ACq by instructing CPX ACq which questions to import after each interview, and tell CPX ASq which questionnaire to use (the links that are imported into each invitation email are all unique to that survey and respondent, and created automatically every time CPX ASq asks for new ones). After this the project manager starts the project (he or she can, if need be, set a whole set of other criteria, ranging from number of send outs per hour, make the send out weighted to take into account women's and men's earlier behaviour when responding to beer interviews (if the drop-out rate tends to be higher or lower), etc, but that is outside of the scope of this presentation. CPX ASq now starts the project in five countries at the same time. CPX ASq does the following simultaneously in these five markets:

Draws the first small sample in each target group, in each country, taking into account the criteria, and the fact that there should be 30 answers from women this first week, and 70 from men, and that the incoming answers need to be nationally representative to the population in each country for age, and region (gender is not at issue here).

As the first day passes into the second, CPX ASq continuously compares the results from the desired need, and makes the necessary changes to the next small batch of send outs. This process is reiterated each day that passes, until the week or wave is over. During the last waves, CPX ASq sees to that the round as such has a zero error in each target group. The incoming answers are stored, but all open answers are sent to CPX ACq, where the words are coded. The number of words given per question is typically about 3.4 (depending on brand knowledge) why each person on average will send in 6.8 words per questionnaire, and since there are about 500 persons that answers each week from the five countries, the number of needed coded words are 3.400 words per week.

If the project manager has so decided, the result from each wave or round is sent through any reporting tool to the client, including the coded results, and as the weeks pass by, the historical record is starting to show (for whatever use).

The project manager may change the setup on a round-basis (i.e. change target group, sizes, criteria, no of waves, etc). That does not change pricing since he/she is only paying for the actual use of system and respondents.

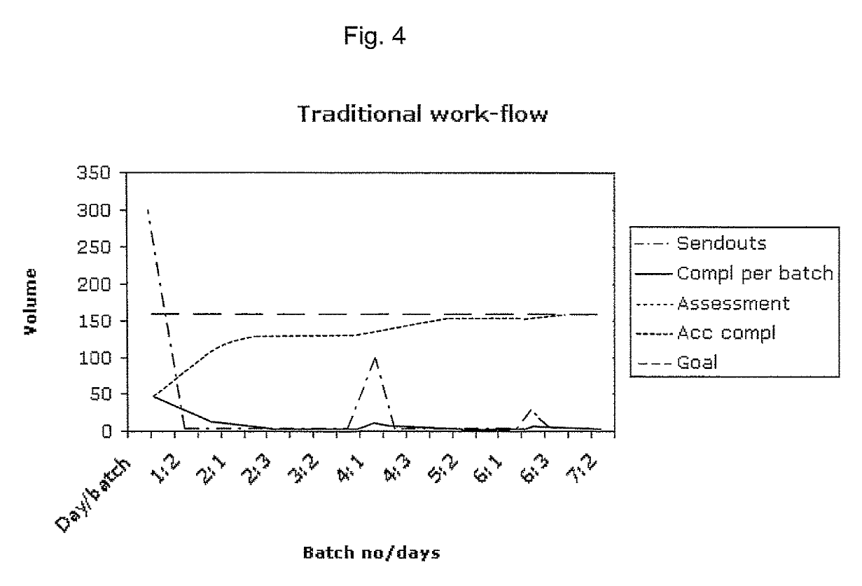

FIG. 4. Effects on number of accumulated completed interviews of a manually labored project. Due to the high costs involved in manual labor, the optimum work-flow, from a process handling point-of-view, is often to do a very large sendout at the start of a project. This translates, however, in a situation where the number of completed interviews spike in the beginning.

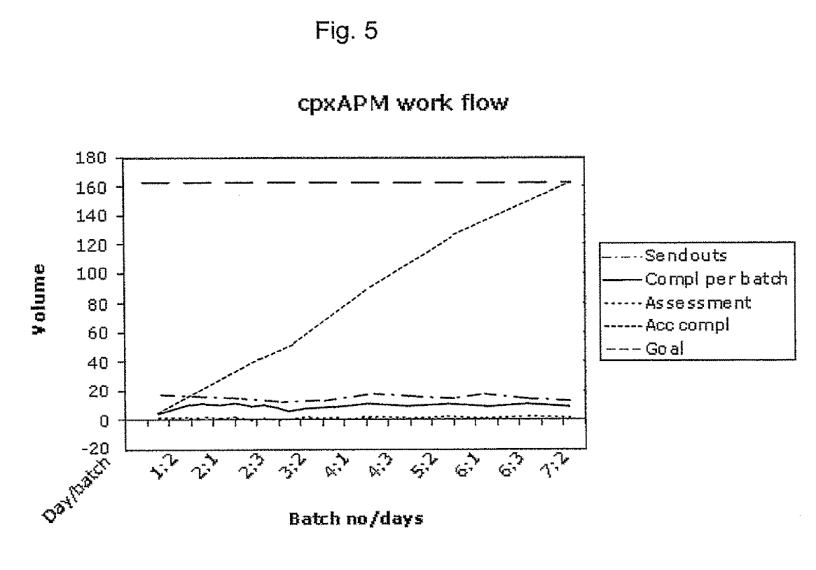

FIG. 5. Effects on number of accumulated completed interviews of CPX APM. As can be seen, the CPX APM, devoid of any cost issues, optimizes instead the number of interviewed completes on any given time-span, which creates a much more smoothed result over this time span. This is done by an algorithm that, given the historic records of the panel used, the panellists included in the sample, the country in question, the target group in question, and the time of year (if there is a Bank Holiday within the time span in question, CPX APM would increase the size of the samples drawn that day if that day earlier has had lower answering rates), tries to predict the typical answering rate of that sample during the time remaining to the end of that particular time period of the project.

After a few batches, CPX APM learns how this particular project behaves, and takes that into consideration also. The survey in itself may affect answering rates, why using only historical data is not enough to predict the outcome of a sample.

Thus, CPX APM is a self-learning and self-adjusting technology, used within the scope of market research, in order to optimize usage of access panels and effectivize the work flow of the project, with as little manual labour involved as possible.

Technical Description of CPX, ASq, ACq

The system is a multi-tiered data heavy solution with a tightly integrated, highly interactive distributed web enabled front-end.

The system runs on conventional hardware, but the software is designed in such a way that it uses as little hardware as possible, including using the client's hardware whenever appropriate. Because of this, there is no description of hardware in this presentation, since it is deemed non-crucial to the successful use of the system.

At the lowest level the system consists of multiple database servers linked via application layers to form a greater whole and context. The basic application architecture supplementing and augmenting that core is built using service oriented paradigms to achieve a high degree of independence and conceptual separation.

Conceptually the system as a whole is distributed over several separate logical domains:

Data Domain

The data domain consists of multiple dedicated or semi dedicated systems currently running Microsoft Windows OS and Sql Servers. Data is considered dumb both to ensure flexibility in service provider ease transitions to new technology and ensure minimal vendor lock in.

Application Domain

The application domain consists of web servers and DCOM (Distributed Componenent Object Model) Applications as well as Asp.Net enabled web servers running .Net applications and several separate Web services built both with SOAP and Json/JsonRpc all communication using encrypted internal connections or secure socket layer.

External Peers

The system aggregates and makes use of external partners and affiliates to enhance user experience and enriching its feature set to provide a complete solution tailored to user needs. In many respects this integration is seamless from user perspective but interactions are closely monitored and mission critical data is not affected by failing peers.

Untrusted User Domain

To maximize efficiency both for end-users and regarding resources such as band-width and computation cycles the system strives to push as much non critical processing to clients as possible using client side technologies and frameworks. This increases scalability by making users somewhat responsible for data processing leaving only validation to the core of the system.

At the core of the system lies flexibility and collaborating creating a diverse ecosphere of languages and technology, yielding maximum flexibility, adaptability and interoperability.

The current platform seamlessly mixes the following mainstream technologies C#, Perl, VB-script, VB, Ajax, Com, .Net Framework 2, SOAP, Json, XML, JavaScript/ECMA-262(?). The system is built with a strong “use the right tool for the job” mindset.

For automated sampling and word coding highly adaptable real time models based on real time feedback loops from collaborating applications and layers are used to provide maximum forecast capabilities and yield solid decision making aids where human intervention is needed.

Where possible collaboration is expanded to include end users and clients to a maximum degree thereby offloading central servers this integration and modularization is made possible by dedicated efforts in easing the transition from client to server without impairing security or data integrity.

Table 1 (Traditional) and Table 2 (New) provide a time comparison regarding different action events relating to a multi-market project.

Apart from this the great time-savings, the actual cost for the sample is less but at the same time the end-seller gets paid better. This is of course that several middleman are cut out of the process. So, in effect, the buyer pays less, and the actual seller earns more. The over-all quality of the project is also higher since there are fewer people involved, only the ones having the highest interest of insuring quality is active.

An aspect of the invention relates to a computer programme comprising a programme code for performing the method steps according to the invention, when the computer programme is run on a computer.

An aspect of the invention relates to a computer programme product comprising a program code stored on computer-readable media for performing the method steps according to the invention, when the computer programme is run on the computer.

An aspect of the invention relates to a computer programme product directly storable in an internal memory of a computer, comprising a computer programme for performing the method steps according to the invention, when the computer programme is run on the computer.

The foregoing description of the preferred embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated.

Time comparison, multimarket project

TABLE 1
(Traditional, Prior Art)

| | Buyer | Seller 1 | Seller 2 |
|---|---|---|---|
| Quotation handling: | 4 h | 0.5 h | 0.5 h |
| Admin of links, redirects | 1 h | 0.5 h | 0.5 h |
| Control of survey | | 1 h | 1 h |
| New samples, sendouts | 1.5 h | 2 h | 2 h |
| Quota handling | 0.5 h | 1 h | 1 h |
| Complete file handling | 1 h | 0.5 h | 0.5 h |
| Miscellanous communication | 2 h | 1 h | 1 h |
| Word coding | 2 h | | |
| Invoicing | | 1 h | 1 h |
| Total | 12 h | 6.5 h | 6.5 h |

| | |
|---|---|
| Gross total: | 25 h on three parties |

TABLE 2
(New, according to an aspect of the Invention)

| | Buyer | Seller 1 | Seller 2 |
|---|---|---|---|
| Quotation handling: | 0.1 h | 0 | 0 |
| Admin of links, redirects | 1 h | 0 | 0 |
| Control of survey | | 1 h | 1 h |
| New samples, sendouts | 0 | 0 | 0 |
| Quota handling | 0 | 0 | 0 |
| Complete file handling | 1 h | 0 | 0 |
| Miscellanous communication | 0.5 h | 0.5 h | 0.5 h |
| Word coding | 0 | | |
| Invoicing | 0.1 | 0 | 0 |
| Total | 2.7 h | 1.5 h | 1.5 h |

| | |
|---|---|
| Gross total: | 5.7 h on three parties, time |
| | spent falls by 75-80% |

1. A project managing unit for managing at least one market research involving a survey to be answered by a plurality of panelists, said unit comprising:
means for receiving a predefined survey information comprising a predefined survey criterion;
means for repeatedly selecting a set of panelists chosen from at least one panel, said selection being based upon said received criterion and/or an updated information regarding survey answer status;
means for generating messages to be sent to the selected panelists, wherein each generated message comprises access information giving the addressed panelist access to the survey;
means for sending said generated messages to corresponding selected panelists; and
means for determining and updating information regarding survey answer status so as to allow an iterative message sending process until a desired result is achieved.

2. The project managing unit according to claim 1, wherein the predefined survey criterion comprises information about number of panelists and/or geographic residence of the panelists and/or gender and/or age of the panelists.

3. The project managing unit according to claim 1, wherein each panel comprises a dynamic predetermined set of panelists.

4. The project managing unit according to claim 1, wherein the determined information regarding survey answer status comprises information about which panelists successfully have responded to the survey in a desired manner.

5. The project managing unit according to claim 1, wherein the result is regarding whether a predetermined ratio of accepted responses to the survey has been achieved or not.

6. The project managing unit according to claim 1, wherein the means for sending said generated messages is arranged to send the messages substantially periodic.

7. The project managing unit according to claim 1, wherein the determination is based upon a successfully answered survey by a panelist.

8. The project managing unit according to claim 1, wherein the messages are e-mails.

9. The project managing unit according to claim 1, wherein the access information is a link, said link being unique and associated with a selected panelist and, when activated, arranged to provide access to the survey.

10. The project managing unit according to claim 1, wherein a selected panelist is prohibited from participating in more than one market survey at the same time, and where a selected panelist having answered the survey will be blocked from participating in other market researches for a predetermined period of time.

11. A method for managing at least one market research involving a survey to be answered by a plurality of panelists, the method comprising:
receiving a predefined survey information comprising a predefined survey criterion;
repeatedly selecting a set of panelists chosen from at least one panel, said selection being based upon said received criterion and/or an updated information regarding survey answer status;
generating messages to be sent to the selected panelists, wherein each generated message comprises access information giving the addressed panelist access to the survey;
sending said generated messages to corresponding selected panelists; and
determining and updating an information regarding survey answer status so as to allow an iterative message sending process until a desired result is achieved.

12. The method according to claim 11, further comprising:
generating a predefined survey information comprising a predefined survey criterion; and
sending said predefined survey information.

13. The method according to claim 11, further comprising:
sending answers associated with the respective generated messages, and
generating an indication signal based upon said answer sending step, which signal may be taken into consideration in said determining step.

14. The method according to claim 13, further comprising:
coding said answers so as to correct faulty information, said coding comprises performing a matching procedure between words of the answers and a set of predetermined words, and eventually correcting misspelled words of the answers based upon said matching procedure.

15. The method according to claim 13, further comprising:
storing the answers so as to allow subsequent analysis.

16. The method according to claim 11, wherein the access information is in the form of a link, said link being unique and associated with a selected panelist and, when activated, arranged to provide access to the survey.

17. The method according to claim 11, further comprising:
prohibiting a selected panelist from participating in more than one market survey at the same time, and
blocking a selected panelist having answered the survey, from participating in other market researches for a predetermined amount of time.

18. The method according to claim 11, further comprising the step of:
invoicing a buyer sending a survey information comprising a predefined survey criterion, which is to be managed as according to the method.

19. The method according to claim 14, further comprising:
invoicing a buyer using the coding.

20. A word coding unit for coding provided information, the word coding unit comprising:
means for storing at least one context, wherein said context is a set of words being associated with a correctly spelled word;
means for coding answers to a survey managed by a project unit so as to correct faulty information, the project unit comprising
means for receiving a predefined survey information comprising a predefined survey criterion, means for repeatedly selecting a set of panelists chosen from at least one panel, said selection being based upon said received criterion and/or an updated information regarding survey answer status,
means for generating messages to be sent to the selected panelists, wherein each generated message comprises access information giving the addressed panelist access to the survey,
means for sending said generated messages to corresponding selected panelists, and
means for determining and updating information regarding survey answer status so as to allow an iterative message sending process until a desired result is achieved;
wherein said coding means comprises means for performing a matching procedure between words of the answers and a relevant context and eventually correcting misspelled words of the answers based upon said matching procedure to determine the correctly spelled word.

21. A word coding unit for coding provided information, the word coding unit comprising:
means for storing at least one context, wherein said context comprises a set of words being associated with a correctly spelled word,
coding means for coding the provided information, based upon said at least one context;
means for adding and/or deleting one ore more words to/from the context; and
means for providing access to the at least one context for an external user of the word coding unit.

22. A system for managing at least one market research, the system comprising:
at least one first communication terminal being operated by a buyer and being arranged for communication with the project managing unit via a network; said project managing unit comprising
means for receiving a predefined survey information comprising a predefined survey criterion, means for repeatedly selecting a set of panelists chosen from at least one panel, said selection being based upon said received criterion and/or an updated information regarding survey answer status,
means for generating messages to be sent to the selected panelists, wherein each generated message comprises access information giving the addressed panelist access to the survey,
means for sending said venerated messages to corresponding selected panelists, and
means for determining and updating information regarding survey answer status so as to allow an iterative message sending process until a desired result is achieved,
said project managing unit also being arranged for communication with a plurality of second communication terminals being operated by panelists.

23. The system for managing at least one market research according to claim 22, further comprising
a word coding unit.

24. The system for managing at least one market research according to, claim 21, wherein said network is the Internet.

25. The system for managing at least one market research according to claim 21, wherein a plurality of market researches involving mutually different predefined pieces of survey information each comprising a predefined unique survey criterion.

26. The system for managing at least one market research according to, claim 21, wherein a panelist may send an answer to the survey directly to a buyer operating the first communication terminal from the second communication terminal.

27. A computer program product, comprising:
a computer readable medium; and
a program code recorded on the computer readable medium and executable by a processor for performing when the computer program code is run on a computer a method comprising
receiving a predefined survey information comprising a predefined survey criterion;
repeatedly selecting a set of panelists chosen from at least one panel, said selection being based upon said received criterion and/or an updated information regarding survey answer status;
generating messages to be sent to the selected panelists, wherein each generated message comprises access information giving the addressed panelist access to the survey;
sending said generated messages to corresponding selected panelists; and
determining and updating an information regarding survey answer status so as to allow an iterative message sending process until a desired result is achieved.

28. The computer program product according to claim 27, wherein the program code is for performing the method further comprising invoicing a buyer sending a survey information comprising a predefined survey criterion, which is to be managed as according to the method when the computer program is run on a computer.

29. The computer program product according to claim 27, wherein the program code is for performing the method further comprising invoicing a buyer using coding of said answers so as to correct faulty information, said coding comprises performing a matching procedure between words of the answers and a set of predetermined words, and eventually correcting misspelled words of the answers based upon said matching procedure when the computer program is run on the computer.

30. (canceled)
